(19) United States
(12) Patent Application Publication
(10) Pub. No.: US 2026/0156158 A1
(43) Pub. Date: Jun. 4, 2026

(54) METHOD AND SYSTEMS FOR NETWORK SECURITY ANALYSIS AND MANAGEMENT USING GRAPH DISTANCE

(71) Applicant: CABLE TELEVISION LABORATORIES, INC., Louisville, CO (US)

(72) Inventors: STEVEN J. GOERINGER, Westminster, CO (US); BRIAN A. SCRIBER, Lafayette, CO (US); CRAIG M. PRATT, Portland, OR (US); ANDREW ALEXANDER DOLAN, Denver, CO (US); ZACKARY FOREMAN, Eugene, OR (US)

(21) Appl. No.: 19/406,469

(22) Filed: Dec. 2, 2025

Related U.S. Application Data
(60) Provisional application No. 63/727,042, filed on Dec. 2, 2024.

(51) Int. Cl. H04L 9/40

(52) U.S. Cl. CPC H04L 63/20; H04L 63/1433

(57) ABSTRACT

A system for network analysis is provided. The system includes a computer device in communication with a computer network. The computer device programmed to: a) analyze a plurality of devices and a plurality of connections between the plurality of devices on the computer network; b) determine values for each of the plurality of connections between the plurality of devices, wherein the plurality of values are determined based on a security posture of two devices of the plurality of devices on ends of the corresponding connection; c) determine a plurality of paths between a first device of the plurality of devices and a second device of the plurality of devices; d) calculate a security value for each of the plurality of paths; and e) determine at least one secure path of the plurality of paths based on a comparison of the plurality of security values for the plurality of paths.

### CROSS REFERENCE TO RELATED APPLICATIONS

This application claims priority to U.S. Provisional Application No. 63/727,042, filed Dec. 2, 2024, the contents of which are incorporated herein by reference in its entirety.

### BACKGROUND

The field of the invention relates generally to network security analysis and management, and more specifically to systems and methods to perform security analysis and management of computer networks using graph distance as a tool.

Accurate and reliable data collection for network security and cryptographic security analysis is critical to operation, safety, sustainability, and future proof networks. Universally all guidance on migrating to post-quantum cryptography (PQC) calls for organizations to create a network security and cryptographic inventory. This is a manifest of all network security and cryptography used in a system, network, or organization, what it protects, and other characteristics, as a key first step. One of the key challenges in creating and leveraging a network security and cryptographic inventory for migrations is charactering it in terms useful to determining which security controls to migrate. Novel metrics are needed to characterize network security and cryptographic controls in terms of their criticality, migration urgency, and ease of migration have been proposed and used to augment exiting risk assessment methodologies to determine prioritization of migration efforts.

Furthermore, the idea of distance as we understand it in the physical world doesn't really apply to the Internet and computer networks. The landscape of computer networks (including the Internet) isn't an analog continuity like our planet. Rather, it is a collection of nodes and interfaces. Culturally, the Internet has always sought to minimize distance—to provide ubiquitous access to all information. This cultural orientation tends towards a highly connected network infrastructure where every node on the network can directly touch (route to) every other node. This doesn't scale well and so network engineers introduce hierarchies and discovery capabilities (routing protocols, DNS). Often those features are intended to be transparent to establishing connectivity and so their contribution to distance may be negligible

This nature of computer networks also increases exposure. If every node is adjacent to every other node (e.g., every node in a network can “see” every other node), then any node can attack any (or even every) node. So, perhaps increasing distance is a nice analogy for the role of network security. In this security context, increasing distance also increases security. This comes at a price—increasing distance introduces complexity and, may as a result decrease the value of a network (or individual nodes). Accordingly, a solution is needed to analyze the ‘distance’ and security between computer nodes, which may improve the accuracy of inspections and analysis.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a system for network analysis of a computer network is provided. The system including a network analysis computer device in communication with a computer network. The network analysis computer device includes at least one processor in communication with at least one memory device. The at least one processor is programmed to: a) analyze a plurality of devices and a plurality of connections between the plurality of devices on the computer network; b) determine values for each of the plurality of connections between the plurality of devices, wherein the plurality of values are determined based on a security posture of two devices of the plurality of devices on ends of the corresponding connection; c) determine a plurality of paths between a first device of the plurality of devices and a second device of the plurality of devices; d) calculate a security value for each of the plurality of paths; and e) determine at least one secure path of the plurality of paths based on a comparison of the plurality of security values for the plurality of paths. The system may have additional, less, or alternate functionalities, including those discussed elsewhere herein.

In another aspect, a computer device for network analysis of a computer network is provided. The computer device includes at least one processor (or “the processor”) in communication with at least one memory device. The processor is programmed to a) analyze a plurality of devices and a plurality of connections between the plurality of devices on the computer network; b) determine values for each of the plurality of connections between the plurality of devices, wherein the plurality of values are determined based on a security posture of two devices of the plurality of devices on ends of the corresponding connection; c) determine a plurality of paths between a first device of the plurality of devices and a second device of the plurality of devices; d) calculate a security value for each of the plurality of paths; and e) determine at least one secure path of the plurality of paths based on a comparison of the plurality of security values for the plurality of paths. The computer device may have additional, less, or alternate functionalities, including those discussed elsewhere herein.

In a further aspect, a computer implemented method for network analysis of a computer network is provided. The method implemented by at least one processor (or “the processor”) in communication with at least one memory device. The method includes a) analyzing a plurality of devices and a plurality of connections between the plurality of devices on the computer network; b) determining values for each of the plurality of connections between the plurality of devices, wherein the plurality of values are determined based on a security posture of two devices of the plurality of devices on ends of the corresponding connection; c) determining a plurality of paths between a first device of the plurality of devices and a second device of the plurality of devices; d) calculating a security value for each of the plurality of paths; and e) determining at least one secure path of the plurality of paths based on a comparison of the plurality of security values for the plurality of paths. The method may have additional, less, or alternate functionalities, including those discussed elsewhere herein.

In one aspect, a system for network analysis of a computer network is provided. The system including a network analysis computer device in communication with a computer network. The network analysis computer device includes at least one processor in communication with at least one memory device. The at least one processor is programmed to: a) analyze a plurality of devices and a plurality of connections between the plurality of devices on the computer network; b) determine values for each of the plurality of devices, wherein the plurality of values are determined based on a security posture of two devices of the plurality of devices on ends of a corresponding connection; c) determine a plurality of paths between a first device of the plurality of devices and a second device of the plurality of devices; d) calculate a security value for each of the plurality of paths; and e) determine at least one secure path of the plurality of paths based on a comparison of the plurality of security values for the plurality of paths. The system may have additional, less, or alternate functionalities, including those discussed elsewhere herein.

In another aspect, a computer device for network analysis of a computer network is provided. The computer device includes at least one processor (or “the processor”) in communication with at least one memory device. The processor is programmed to a) analyze a plurality of devices and a plurality of connections between the plurality of devices on the computer network; b) determine values for each of the plurality of devices, wherein the plurality of values are determined based on a security posture of two devices of the plurality of devices on ends of a corresponding connection; c) determine a plurality of paths between a first device of the plurality of devices and a second device of the plurality of devices; d) calculate a security value for each of the plurality of paths; and e) determine at least one secure path of the plurality of paths based on a comparison of the plurality of security values for the plurality of paths. The computer device may have additional, less, or alternate functionalities, including those discussed elsewhere herein.

In a further aspect, a computer implemented method for network analysis of a computer network is provided. The method implemented by at least one processor (or “the processor”) in communication with at least one memory device. The method includes a) analyzing a plurality of devices and a plurality of connections between the plurality of devices on the computer network; b) determining values for each of the plurality of devices, wherein the plurality of values are determined based on a security posture of two devices of the plurality of devices on ends of a corresponding connection; c) determining a plurality of paths between a first device of the plurality of devices and a second device of the plurality of devices; d) calculating a security value for each of the plurality of paths; and e) determining at least one secure path of the plurality of paths based on a comparison of the plurality of security values for the plurality of paths. The method may have additional, less, or alternate functionalities, including those discussed elsewhere herein.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The Figures described below depict various aspects of the systems and methods disclosed. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. There are shown in the drawings arrangements presently discussed, it being understood, however, that the present embodiments are not limited to the precise arrangements.

FIGS. 1A-1D illustrate example graphs for representing security as graph distance, in accordance with at least one embodiment.

FIG. 2A illustrates an example block diagram of a computer network where the connections are analyzed and weighed, in accordance with at least one embodiment.

FIG. 2B illustrates an example block diagram of a computer network where the devices are analyzed and weighed, in accordance with at least one embodiment.

FIG. 3 illustrates an example process for analyzing the computer network shown in FIG. 2.

FIG. 4 illustrates an exemplary computer system for network analysis, in accordance with at least one embodiment.

FIG. 5 illustrates an example block diagram of interconnecting Autonomous Systems in an interconnected system to illustrate border gateway routing.

FIG. 6 illustrates a block diagram of a system for routing is based on policies.

FIG. 7 illustrates a system for policy control in an RSVP Router after IETF RFC 2753 is implemented.

FIG. 8 illustrates a block diagram of a system content delivery network (CDN) operation using the method described herein.

FIG. 9 illustrates an object oriented architecture with a security call graph database (SCGD).

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

The present embodiments may relate to, inter alia, systems and methods to perform security analysis and management of computer networks using graph distance as a tool. The systems and methods presented in this disclosure describe a computer network inspection and analysis system to detect and provide solutions for potential network issues related to network security and cryptography in real-time or near real-time.

The present disclosure recites a method of factoring security-related measures into such definitions so as to enable all existing optimization algorithms to incorporate security considerations in decision making. Furthermore, the disclosure teaches a specific embodiments that implement this method. One having ordinary skill in the art would understand that other embodiments and/or implementations would work as well. The disclosure also teaches various applications of the invented methods to the fields of telecommunications, object-oriented distributed processing, network API design, and business decision support systems.

To address the shortcomings described above, a network analysis system is proposed that uses graph theory to be applied to use cases for prioritizing migrations of network and cryptographic security controls to new network and security network and cryptographic primitives and paradigms such as post-quantum cryptography (PQC). As graphs have been a natural mathematical structure used in modeling of various computing- business- and communications-network applications, a variety of graph-based algorithms (such as, but not limited to, network flow optimization, shortest-path computation, compiler code generation, path analysis in workflow optimization, or Content Delivery “closest server” location) have been developed based on the notion of the distance between two connected graph nodes. Depending on a specific application such distance may be defined as capacity of a network link, or geographic distance, etc.

The present disclosure also serves to optimize the process of network security analysis in several ways and under several constructions. First, the network security and cryptographic inventory is modeled as a graph, where each node represents some system or component that employs network security or cryptographic controls for some purpose. The edges that connect these nodes then represent the different network security or cryptographic controls that are employed. Depending on what is being modeled, these edges may connect nodes in ways that correspond to different employments of network security or cryptographic controls. Examples of the meaning behind nodes connected by edges representing network security or cryptographic controls include: Network connections between devices that are protected by a secure protocol with a network security and cryptographic component; and Internal communications of data whose confidentiality and/or integrity is protected with network security and cryptographic methods between components in a software architecture or distributed system.

The edges of such a graph can also be directed to delineate between where the actual implementation of each network security and cryptographic controls are resident (e.g., on each node that utilizes a network protocol secured with a network security and/or cryptographic control).

With such a graph constructed, the edges can then be assigned values that can indicate a number of migration-relevant metrics. An example of a metric includes the criticality of the network security and/or cryptographic control, in terms of the data it protects, its confidentiality lifetime, such as defined in the Mosca Theorem. Another metric could be the ease of migration of the network security and/or cryptographic control. This could be characterized in terms of its network security and/or cryptographic agility, which a number of frameworks have been developed to calculate. These frameworks include, but are not limited to, the [Crypto Agility Risk Assessment Framework] (CARAF); and the ATIS [Strategic Framework for Crypto Agility and Quantum Risk Assessment]. A simple binary metric (0 or 1) could represent whether or not the network security and/or cryptographic control represented by the edge is quantum-safe or vulnerable to the threat posed by a cryptographically relevant quantum computer.

The system could apply a combination of these metrics, so that a higher (or lower) value would indicate a more critical control that has more ease of migration.

Once these values are assigned to the edges of the network security and/or cryptographic inventory graph, different graph theory algorithms can then be applied to find optimal solution paths for network security and/or cryptographic graphic migrations and other network security and/or cryptographic use cases. As one example, nodes with the highest (or lowest) total sum values of their connected edges could be identified as prime candidates for devices or components to prioritize for migration, yielding high optimal migration impact and migration cost. In highly connected graphs, shortest path algorithms could be employed to evaluate high-priority paths for migration across multiple components. Further, applying migration complexity metrics to the edges can also help identify areas of a network or system in which there are network security and/or cryptographic controls that are critical, but infeasible to migrate in a cost-effective way. In these cases, the value of the migration complexity metric could be infinity. In a network graph in which edges are assigned values based (at least in part) on the quantum-safety of a connection, graph algorithms can be applied to determine the shortest quantum-safe path.

Other embodiments of this invention look at applying the systems and methods described herein for finding a most secure path between objects. This embodiment offers up a different perspective. One such that it allows those in a position of overseeing and allocating resources an ability to quantify reasoning for spending resources on a specific task. Instead of looking at the whole security metric of the entire graph, the system can look at the security metric of paths individually.

It is well known that those who perform offensive cyber security tasks, utilize graphs for developing attack trees for gaining access to an asset in a system. If this thought process is inverted and used to develop a graph for all the layers that lead to an asset, then the system can be viewed this from a perspective of weaknesses and vulnerabilities that could potentially allow unwanted access to an asset.

By looking at the perspective of weaknesses, every system has some type of inherit weakness. Many of the common software and hardware weaknesses are enumerated in the Common Weakness Enumeration hosted by MITRE. If the system draws out a graph showing all the paths of a system to an asset, the system can detect the potential avenue for an attacker to take to gain access to this asset. The system assigns each interface an attacker must bypass as a node, then the potential next paths as the edges. From the information presented earlier with creating a common security metric, if applied to weaknesses from the Common Weakness Enumeration, the system could rank the paths of most likely attempt to potentially be exploited. With this information it allows for potentially either adding another layer in a path of most likely to be exploited, or it allows for potentially implement another layer to swap with that node.

When looking at a vulnerability, this is a published recipe of steps of weaknesses that must be exploited to gain access to an asset or ability to traverse a node. There are many openly published sources of truths for known vulnerabilities one can use to know for their system. However, these vulnerabilities often scope things from a single perspective, thus are not always applicable to all systems in the same manor.

When the system takes graph that illustrates/analyzes weaknesses, in addition applying known vulnerabilities of the system to the graph, the system is able to provide a metric to help determine where to allocate limited resources in order to help quantify where to allocate resources.

One having ordinary skill in the art would understand that in some embodiments, the systems and methods described herein calculate and assign the metrics, then use those as inputs to graph theory. In other embodiments, the systems and methods described herein use graph theory to calculate and assign metrics for analyzing computer networks. At least one example includes finding the node with the largest sum weights of all its connections.

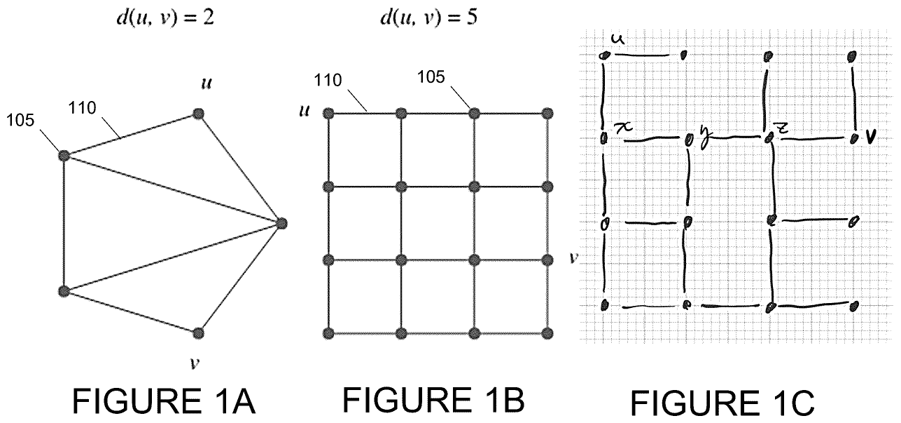

FIGS. 1A-1D illustrate example graphs for representing security as graph distance, in accordance with at least one embodiment.

FIGS. 1A and 1B each illustrate an example flattened graph showing how distance may be measured. More specifically, the distance d(u,v) between two vertices u and v 105 of a finite graph is the minimum length of the paths connecting them (i.e., the length of a graph geodesic). The connection between two adjacent vertices 105 is an edge 110. If no such path exists (i.e., if the vertices 105 lie in different connected components), then the distance is set equal to infinity. In a grid, graph the distance between two vertices 105 is the sum of the “vertical” and the “horizontal” distances as shown in FIG. 1B. In FIG. 1A, the equation d(u,v)=2 as there are two steps between the vertices 105 u and v. In FIG. 1B, the equation d(u,v)=5 as there are two vertical steps and three horizontal steps between the vertices u and v.

As used herein, the matrix dᵢⱼ consisting of all distances from vertex vi to vertex vⱼ is known as the all-pairs shortest path matrix, or more simply, the graph distance matrix.

This can be used for security as represented by Graph Distance. Of any edge 110=a weight of the effectiveness of a control (perhaps equivalent to security bits which is a measure of the computational resource to break a network security and/or cryptographic control)/by the number of edges 110 (as a proxy for the exposure) possibly multiplied by the value of the edge 110. Thus, the sum of edges 110 provides a proxy for the security of a path.

FIG. 1C illustrates an example graph for representing security as graph distance. In FIG. 1C, V is value, D is degree, Sw is security weight, and S is security path. Accordingly, the security degree of vertex u 105 can be represented as:

$${u}_{D} = \frac{{s}_{w}}{\sum {u}_{i}} \qquad EQ . 1$$

Alternating with

$${u}_{D} = \frac{{s}_{w}}{\sum {u}_{i} xv} \qquad EQ . 2$$

$${S}_{D} ( u , v ) = {u}_{D} + {x}_{D} + {y}_{D} + {z}_{D} + {v}_{D} \qquad EQ . 3$$

The Security weight is equal to the effectiveness of security at that point—vulnerabilities, of course, decrease or eliminate security weight. This can be viewed at multiple layers (link, network, application) but is most relevant at the flow layer (process to process).

Moreover, while it is tempting to think of the vertices 105 of the graph as devices (gateway, router, firewall, laptop, etc. . . . ), it may be more useful to think in terms of finer granularity (Inter device or sub-system granularity) wherever access to resources or capabilities can be achieved (and therefore security controls applied). Furthermore, it is tempting to concentrate on “enforcement points;” it may not be practical or necessary to assert security controls at every edge 110 where functions can be.

FIG. 1D illustrates a graph of a multidimensional network with its interconnections. Most people think of a network in very simple terms. Device to GW to router (*n) to GW to Device. Real services are much more complex. While the data plane connectivity may be very linear, the service will also include management, control, and people. It is useful to model these as “planes,” each as its own graph. However, these distinct graphs actually interface with each other and so a real service will be a very complex, multidimensional entity. Each aspect of operation in this multi-dimensional graph can have its own paths. This is, actually, a sound security practice and the stronger the separation between planes, the more likely a given service is to be secure. For example, data plane and control plane separation is a known effective security practices (though modern architectures such as virtualization or software defined network often break this separation). Sometimes, this is referred to as “out of band,” usually relative to control or management plane connectivity being provided separately from the data plane.

The security degree of a given service therefor can be computed as the sum of SecurityDegrees of the Security Paths in each plane. This, however, is not complete as there can be edges 110 at vertices 105 between the planes. The Security degree of a given service therefor can be computed as the sum of Security degree of vertices 105 of all planes. However, if edges between planes are included, there can be double accounting. In some embodiments, it may be preferable to measure SecurityDegree of a service along a path based on the complete sequence diagram of all operations invoked to provide a service. Note that as there are multiple planes participating in service delivery, there may be multiple concurrent sequences invoked to implement a given service. This will increase the complexity of compiling and modeling.

One of the most insidious security threats is the insider as a bad actor. In traditional network engineering—or network security engineering—personnel are rarely included. People in themselves form networks and consequently can be modeled as a graph and create an additional plane. As they interact with devices (processes, applications) in other planes, they can increase or decrease security weight. Vulnerabilities decrease or nullify Security Weight at vertices or bypass vertices complete. In this context, vulnerabilities decrease the Security degree of any given Path.

One use of graph based security computations can be applied to create security-based routing. Consider an Open Shortest Path First (OSPF) approach where routing can be balanced to maximize the security degree while tempered against usability. In other words, balancing between shortest path (least cost, highest performance) and shortest secure path. Usability can be assessed in this way. The greater the graph distance, the lower the usability, but perhaps the greater security. The idea of territory can also be applied in this way. Certain vertices can have very high security weights and serve as borders in internet topology.

In Graph Theory, a graph is defined as a set G(V,E) of, respectively, a set of vertices 105 V and edges 110 E c V×V that connect vertices. If all pairs in E are ordered, the graph is called directed. Furthermore, edges 110 may be assigned a distance by a mapping d: E->R⁺ of the edges 110 to non-negative real numbers.

The definition of such mapping belongs in the realm of a specific application. For example, for geographic mapping services and/or processes, the distance may be defined as the length of a direct road connecting these geographic points. (If there is no such road, then the distance may be computed as the length of a route containing different roads connecting these points. With that, mapping software may optimize the route by selecting the fastest route.)

In the general case, with the above definition of the distance, there are well known and efficient algorithms that determine the shortest path for each pair of vertices in a directed graph. These algorithms are being used, for example, in data communications network routing in which the vertices are routers and the distance is defined by a metric, which is computed based on the link capacity. This specific example is important inasmuch as it shall serve as one of the embodiments of the present invention.

A rather simple one-factor metric is used in the routing protocol called Open Shortest Path First (OSPF), and a more complex multi-factor one is used in the Border Gateway Protocol (BGP), used for interconnecting autonomous networks. Similar metrics are defined in plethora of protocols that ensure quality-of-service (QOS) and used in the mechanisms for establishing and maintaining semi-permanent network routes as in the case of Multi-Protocol Label Switching (MPLS). Yet another example—particularly relevant to telecommunications service providers-is Content Delivery Network, in which the graph nodes are user clients and content delivery servers, and the metrics are defined based on multiple factors that include geographic distance and quality-of-service parameters.

None of the metrics in the above examples take into account security metrics, probably because measuring security posture is a fairly new discipline. To this end, the following six measurements may be used: Vulnerability Management Metrics, Incident Response Metrics, Compliance Metrics, Risk Management Metrics, Awareness Metrics, and Asset Management Metrics. This list is by no means exhaustive, and other metrics and/or measurements may be used with the systems and methods described herein. The present disclosure provides, by means of scaling supports the use of any properly defined metrics and also teaches how to integrate the use of security metrics with other metrics to obtain a compound effect.

The network analysis computer device 410 described herein uses security metrics in finding optimal solutions for problems that involve interconnection of independent components. First, the network analysis computer device 410 establishes that security metrics can be used alone for determining the path for interconnecting any two nodes in a graph-based system. Such a system can be, but is not limited to, a Network of routing devices; a Set of content delivery network caching servers; a Network of software objects offering an implementation of an advertised object-oriented interface; and/or a Network of modules in a business workflow.

In what follows, the disclosure recites a mechanism for labeling graphs according to the invented security model and then demonstrates the four embodiments of the systems described in the previous paragraph.

In the presence of n various security metrics, mᵢ, m₂, . . . mₙ, a unified metric ƒ(mi, m₂, . . . mₙ) is established. This can be achieved in multiple ways as long as the following conditions hold: 1. ƒ is non-negative; 2. Each measure argument contributes to the value of ƒ as appropriate for a specific application; and 3. The meaning of the value of ƒ is such that a smaller value means better security.

Below is demonstrated an example function/algorithm to define function ƒ, aka the unified metric. One having ordinary skill in the art would understand that a specific choice of a function is not prescribed by this disclosure as it may be based on a specific application needs.

As input, this example algorithm receives 1) a set of security measurements {m₁, m₂, . . . mₙ} and a set of contributing weights {w₁, w₂, . . . wₙ} assigned to the above measurements. Step 1 is to convert to a min problem. For each i∈{1, . . . n}, if m; is defined to diminish to indicate a larger security problem, then

$${m}_{i} ← \frac{1}{{m}_{i}} .$$

Step 2 is to scale the measurements using the max and min range values. For each i∈{1, . . . n}, let minᵢ and maxᵢ are defined to be the border range values for mᵢ, then

$${m}_{i} ← \frac{{m}_{i}}{{max}_{i - {min}_{i}}} .$$

In Step 3, the output is returned as EQ. 4.

$$\frac{{\sum }_{i = 1}^{n} {w}_{i} {m}_{i}}{{\sum }_{i = 1}^{n} {w}_{i}} \qquad EQ . 4$$

The above is an example, which establishes a linear dependence of various measurements. It is parameterized to allow a continuum of functions to be selected, according to the weights chosen. One having ordinary skill in the art would understand that other algorithms could be used based on the individual set-up as required.

Now that unified metric is established, the network analysis computer device 410 can solve the based problem as follows. The network analysis computer device 410 labels the edges 110 of a graph with the respective metric values, and so to determine the most secure path between the nodes. Then the network analysis computer device 410 can run a shortest-path algorithm of choice.

Analogously, in the presence of other metrics that affect decision making, a unified metric can be created to factor in security, using precisely the same algorithm described above. For instance, whereas a forwarding decision is to be made by a router based on its calculation of the shortest path in terms of capacity, the network analysis computer device 410 can use the above algorithm and one or more protocols described herein, by unifying the capacity metrics c with the security metric s via a function F(c, s) chosen by the network owner according to the respective business objectives.

As an embodiment example, the network analysis computer device 410 may use F(c,s)=Ws+1/c, with the weight W chosen to emphasize the security factor as fits the stated business objectives.

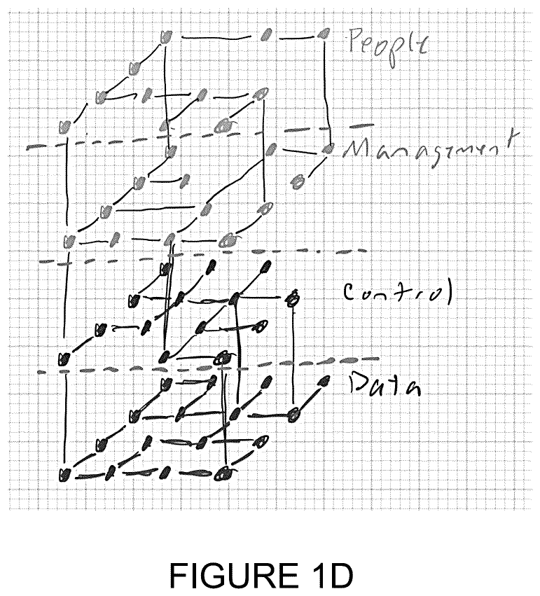

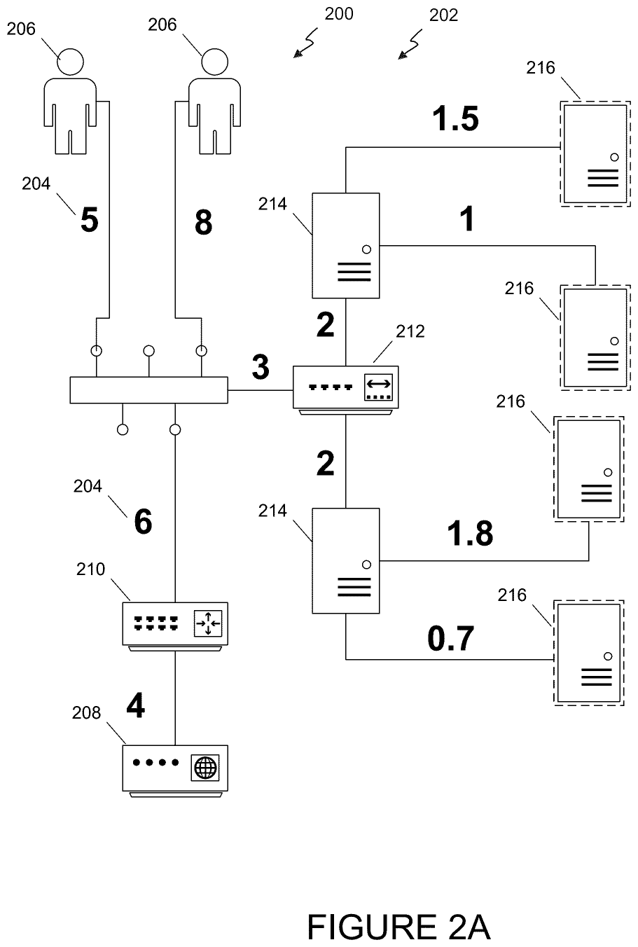

FIG. 2A illustrates an example block diagram of a computer network 200 where the connections are analyzed and weighed, in accordance with at least one embodiment. FIG. 2B illustrates an example block diagram of a computer network 200 where the devices 202 are analyzed and weighed, in accordance with at least one embodiment. These two Figures represent different embodiments described herein, where the values 204 may be assigned to the vertices 105 or the edges 110 (both shown in FIG. 1).

Computer network 200 includes a plurality of devices 202. For this example, the computer network 200 is a core network or an enterprise network. Also the network 200 shown here is drastically simplified, and one having ordinary skill in the art would understand that the systems and method described herein may be applied to different network devices and scaled up to different numbers of devices in that network.

Computer network 200 includes user devices 206. These may be computer devices 202 assigned to individuals, such as, but not limited to, employees, students, members of a household, etc. In this embodiment, the computer network 200 includes a core network device 208 for connecting the network 200 to other networks 200, such as through the Internet. The computer network 200 may also include one or more modem devices 210 and one or more hubs 212. In this embodiment, the hub 212 connects to physical servers 214. The network 200 may also include a plurality of virtual servers 216 that are considered full actors in the computer network.

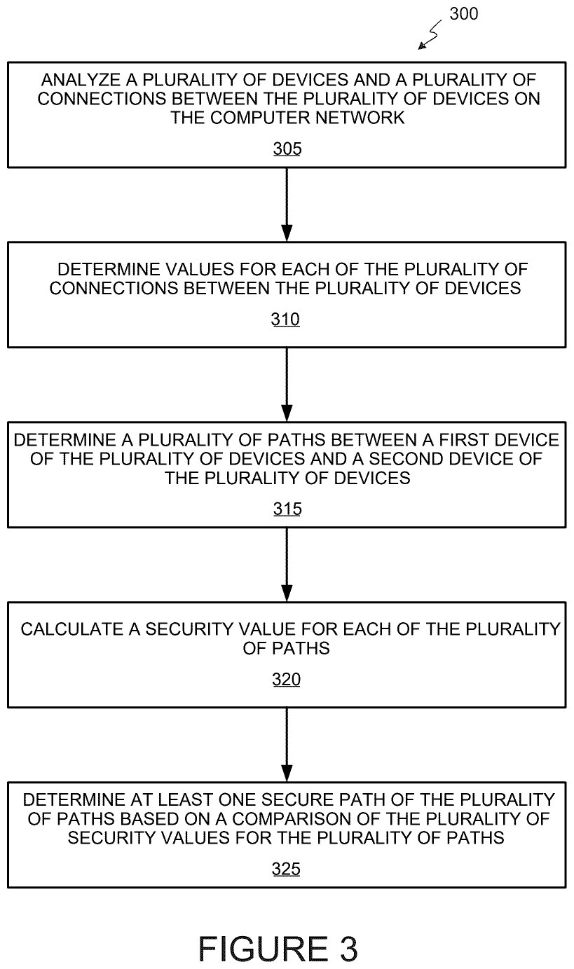

In FIG. 2A, each connection between devices is an edge 110. The network analysis computer device 410 (shown in FIG. 4) has assigned a value 204 to each edge 110. This value 204 is based on the effective and/or relative security of the corresponding connection 110.

In FIG. 2B, each device is a vertex 105. The network analysis computer device 410 has assigned a value 204 to each vertex 105. This value 204 is based on the effective and/or relative security of the corresponding devices 202.

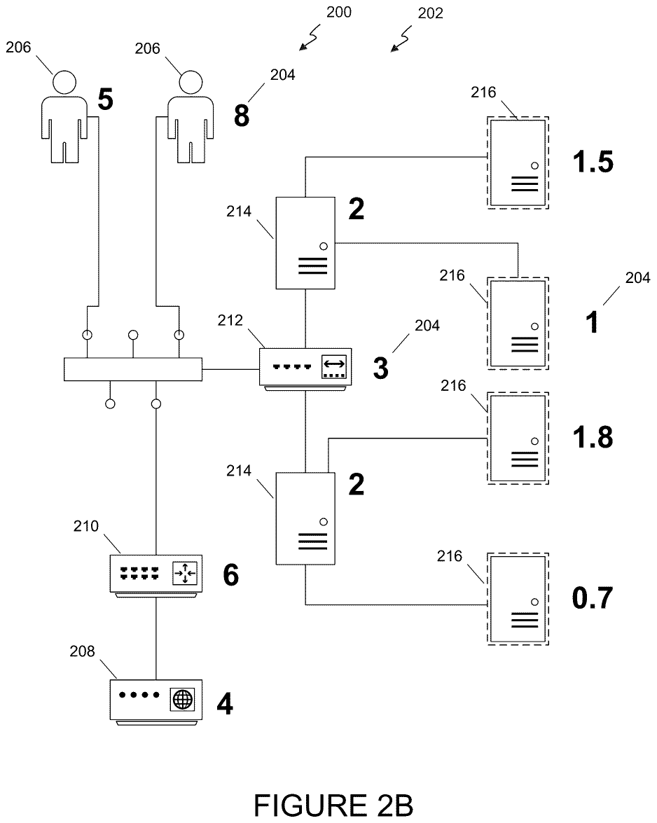

FIG. 3 illustrates an example process 300 for analyzing the computer network 200 (shown in FIG. 2). In the example embodiment, the steps of process 300 are performed by the network analysis computer device 410 (shown in FIG. 4).

In the example embodiment, the network analysis computer device 410 analyzes 305 a plurality of devices 202 (shown in FIG. 2A) and a plurality of connections 110 (shown in FIG. 1A) between the plurality of devices 202 on the computer network 200 (shown in FIG. 2). In some embodiments, the network analysis computer device 410 is in communication with the devices 202 of the computer network 200 and determines the hardware, software, and firmware associated with that device 202. In other embodiments, the network analysis computer device 410 is only in communication with one or two devices 202 on the computer network 200, such as a gateway, and learns about the plurality of devices 202 on the computer network 200 from those one or two devices 202. This may include versions, services, processes, programs, settings, and other details about the device 202. The device 202 may be a computing device, a network device 425 (shown in FIG. 4), a virtual device 216 (shown in FIG. 2A), and/or any other device as desired by the user. Furthermore, the plurality of devices 202 may be broken down into services, processes, and different security layers, such as shown in FIG. 1D.

In the example embodiment, the network analysis computer device 410 determines 310 values 204 (shown in FIG. 2A) for each of the plurality of connections 110 between the plurality of devices 202. The plurality of values 204 are determined based on a security posture of two devices 202 of the plurality of devices 202 on ends of the corresponding connection 110. In some embodiments, the plurality of values 204 are determined 310 at least in part on one or more services or processes operating on the two devices 202 on the ends of the corresponding connection 110. In further embodiments, the plurality of values 204 are determined 310 at least in part on one or more software applications operating on the two devices 202 on the ends of the corresponding connection 110. In still further embodiments, the plurality of values 204 are determined at least in part on a network security and/or cryptographic controls of the two devices 202 on the ends of the corresponding connection 110. In some embodiments, the values 204 are assigned to the connections 110 and in other embodiments, the values 204 are assigned to the devices 202. These represent two different ways to analyze the network 200 as shown in FIGS. 2A and 2B.

In the example embodiment, the network analysis computer device 410 determines 315 a plurality of paths between a first device 202 of the plurality of devices 202 and a second device 202 of the plurality of devices 202. In some embodiments, the first device 202 and the second device 202 are on the same computer network 200. In other embodiments, the first device 202 and the second device 202 are on different computer networks 200. In these embodiments, the network analysis computer device 410 has analyzed 305 and determined values 204 for the connections 110 between the devices 202 on both computer networks 200 and any computer networks 200 between the two networks 200 containing the first device 202 and the second device 202.

In the example embodiment, the network analysis computer device 410 calculates 320 a security value for each of the plurality of paths. The network analysis computer device 410 calculates 320 the security value for each of the plurality of paths based on the corresponding plurality of values 204 for the connections 110 in the corresponding path.

In the example embodiment, the network analysis computer device 410 determines 325 at least one secure path of the plurality of paths based on a comparison of the plurality of security values for the plurality of paths. In some embodiments, the network analysis computer device 410 determines 325 the at least one secure path by comparing the plurality of security values to one or more thresholds. In these embodiments, the network analysis computer device 410 only allows paths that meet or exceed one of more thresholds of safety. In some embodiments, the network analysis computer device 410 determines 325 the at least one secure first path of the plurality of paths based on a comparison of the plurality of security values for the plurality of paths and one or more shortest path algorithms.

In some embodiments, the plurality of values 204 are weighted so that a lower value 204 is relatively more secure. In these embodiments, the plurality of values 204 are weighted so that shortest path algorithms may be used with the system 400. The level of security may be based on one or more security metrics, such as, but not limited to, those provided by the NIST Cybersecurity Framework (CSF). In other embodiments, the plurality of values 204 are weighted so that a higher value 204 is relatively more secure. These are configured for other algorithms and may also be based upon the CSF and other security frameworks. At least one example includes finding the node with the largest sum weights of all its connections 110 to find the most secure or insecure node.

In some further embodiments, the plurality of values 204 are determined based on a quantum-safety of a connection 110. The network analysis computer device 410 determines 325 a shortest quantum-safe path.

In some further embodiments, the network analysis computer device 410 determines one or more changes to a device 202 of the plurality of devices 202 to improve the values 204 of one or more connections 110 connected to that device 202. In these embodiments, the changes may include, but are not limited to, upgrading a version of software or firmware, replacing a hardware or software piece, changing one or more settings, and/or any other update and/or change.

In some further embodiments, the network analysis computer device uses graph theory to calculate one or more metrics associated with the plurality of values 204. These metrics may then be used to create values 204 for devices 202 and/or connections 110. The metrics may also be used to determine a secure path.

One having ordinary skill in the art would understand that in some embodiments, the systems and methods described herein calculate and assign the metrics, then use those as inputs to graph theory. In other embodiments, the systems and methods described herein use graph theory to calculate and assign metrics for analyzing computer networks. At least one example includes finding the node with the largest sum weights of all its connections 110.

FIG. 4 illustrates an exemplary computer system 400 for network analysis, in accordance with at least one embodiment. In the exemplary embodiment, the system 400 provides to near-real time analysis of paths between computer devices 202 on one or more computer networks 200 (both shown in FIGS. 2A and 2B).

As described below in more detail, the network analysis computing device 410 may be programmed for real-time analysis of paths between computer devices 202 on one or more computer networks 200. In some embodiments, the network analysis computing device 410 may be programmed to: a) analyze 305 a plurality of devices 202 and a plurality of connections 110 (shown in FIG. 1) between the plurality of devices 202 on the computer network 200; b) determine 310 values 204 for each of the plurality of connections 110 between the plurality of devices 202, wherein the plurality of values 204 are determined based on a security posture of two devices 202 of the plurality of devices 202 on ends of the corresponding connection 110; c) determine 315 a plurality of paths between a first device 202 of the plurality of devices 202 and a second device 202 of the plurality of devices 202; d) calculate 320 a security value for each of the plurality of paths; and e) determine 325 at least one secure path of the plurality of paths based on a comparison of the plurality of security values for the plurality of paths.

In the example embodiment, user computer devices 405 are computers that include a web browser or a software application, which enables user computer devices 405 to communicate with network analysis computing device 410 using the Internet, a local area network (LAN), or a wide area network (WAN). In some embodiments, the user computer devices 405 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User computer devices 405 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In some embodiments, user computing device 405 may be similar to user devices 206 (shown in FIG. 2A).

In the example embodiment, the network analysis computing device 410 is a computer that include a web browser or a software application, which enables network analysis computing device 410 to communicate with user computer devices 405 and other network devices 425 and devices 202 through various wired or wireless interfaces including without limitation a network, such as a local area network (LAN) or a wide area network (WAN), dial-in-connections, cable modems, Internet connection, wireless, and special high-speed Integrated Services Digital Network (ISDN) lines. Furthermore, network analysis computing device 410 may include an artificial intelligence (AI) and/or an AI/deep learning module for training and/or updating a network analysis AI. In some embodiments, network analysis computing device 410 may be implemented as a server computing device with artificial intelligence and deep learning functionality. In some of these embodiments, the network analysis computing device 410 executes the network analysis AI. In some embodiments, the network analysis computing device 410 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The network analysis computing device 410 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 415 is communicatively coupled to a database 420 that stores data. In one embodiment, the database 420 is a database that includes computer device weights, vulnerability weights, pathing formulas, and/or settings. In some embodiments, the database 420 is stored remotely from the network analysis computing device 410. In some embodiments, the database 420 is decentralized. In the example embodiment, a person can access the database 420 via the user computer devices 405 by logging onto network analysis computing device 410.

A network device 425 may be any computer device 202 in a computer network 200. The network device 425 may be analyzed by the network analysis computer device 410. In some embodiments, the network analysis computer device 410 requests information from each network device 425 on the computer network 200 to determine values 204 for that network device 425 and/or its connections 110. In other embodiments, the network analysis computer device 410 receives the information from one or more network devices 425, such as a gateway or other network device 425 that collects data about the computer network 200. In the example embodiment, network devices 425 are computers that include a web browser or a software application, which enables network devices 425 to communicate with the network analysis computing device 410 using the Internet, a local area network (LAN), or a wide area network (WAN). In some embodiments, the network devices 425 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Network devices 425 can be any device capable of accessing a network, such as the Internet, including, but not limited to, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

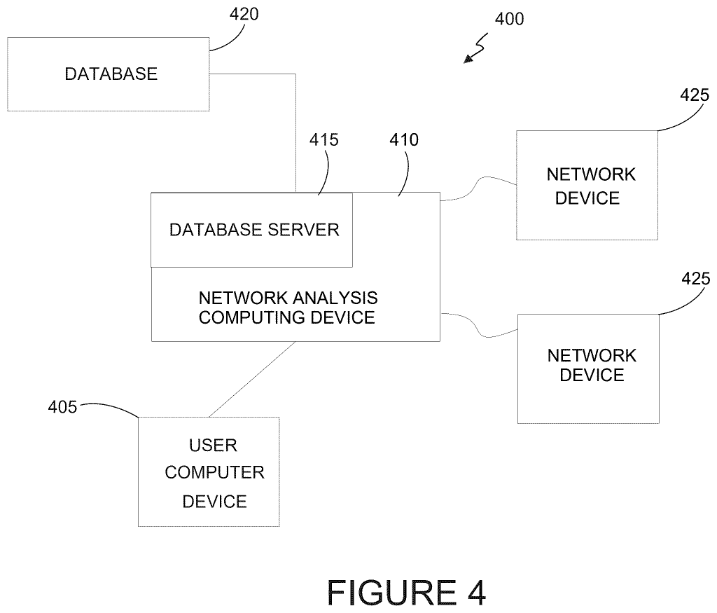

FIG. 5 illustrates an example block diagram of interconnecting Autonomous Systems 505 in an interconnected system 500 to illustrate border gateway routing. More specifically, the routing for interconnecting Autonomous Systems 505 operates differently from routing within an Autonomous System 505. For this reason, different embodiments may require different apparatuses as well as a different sets of mechanisms.

As depicted in FIG. 5, the routing within an Autonomous System 505 is performed according solely by the mechanisms established by the network provider (such as Verizon, AT&T, or Comcast) who owns this system 505. A typical distributed mechanism for computing a route is based on the OSPF protocol. In this situation the routers 510 exchange the information gained from their neighbors. To apply the security-based metrics the network analysis computer device 410 (shown in FIG. 4) needs to update the internal metric value in each router 510.

The routing among the Autonomous Systems 505 is much more involved since, in general, those not only belong to different providers, but to different countries, which naturally makes security considerations much more important.

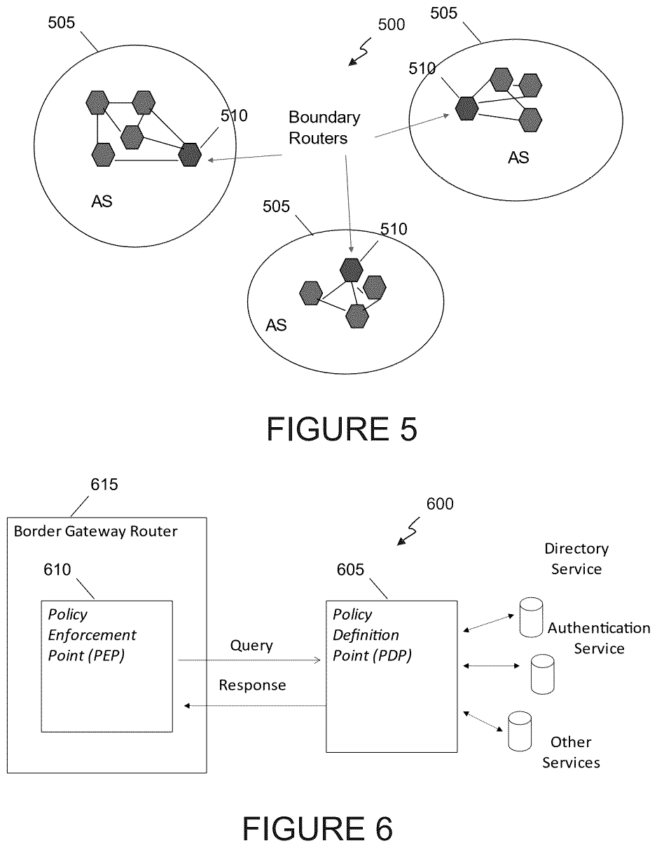

FIG. 6 illustrates a block diagram of a system 600 for routing is based on policies. This is based upon the IETF RFC 2753.

The insertion of the security-metrics so as to affect the routing, in this embodiment, can be performed via a separate plug-in database (allowed by standard), marked “Other Services.” This description is just an example to demonstrate an embodiment. This example algorithm is to feed the security-metrics-based policy into the Policy Definition Point 605, which will send an appropriate instruction in response to a query from the Policy Enforcement Point (PEP) 610, which is located within a border gateway router 615.

The above policy scheme, which is the industry standard, applies to a wider area, which includes the Quality of Service (QoS). Consequently, the network analysis computer device 410 (shown in FIG. 4) provides one respective embodiment in which the path establishment for Multi-Protocol Label Switching (MPLS)—or for that matter, any other virtual-circuit-switched path, is carried by the Resource Reservation Protocol-Traffic Engineering (RSVP-TE) is an extension of the Resource Reservation Protocol (RSVP) for traffic engineering. The network analysis computer device 410 supports the reservation of resources across an IP network.

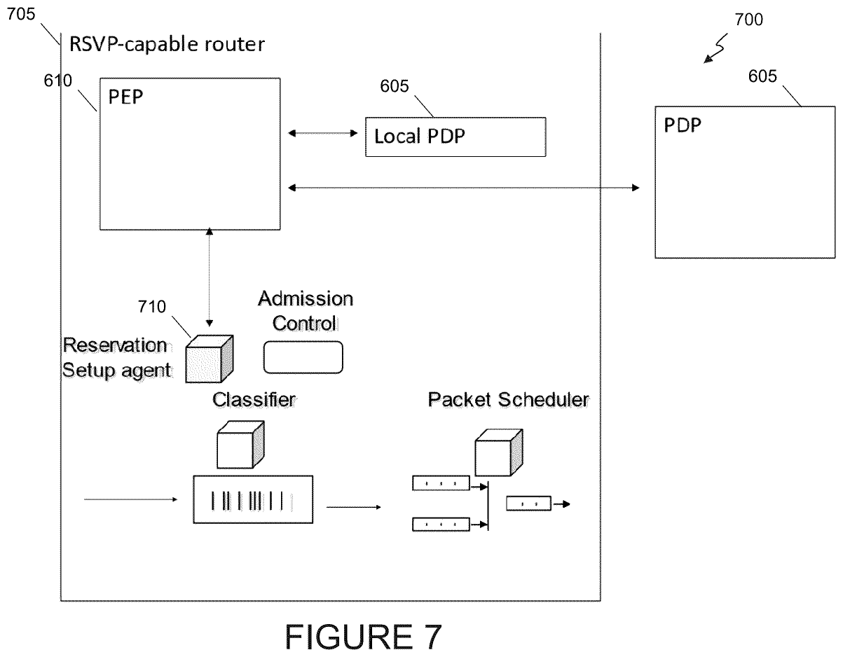

FIG. 7 illustrates a system 700 for policy control in an RSVP Router 705 after IETF RFC 2753 is implemented. As before, the mechanism described in FIG. 7 is an embodiment that demonstrates an implementation of the method presently taught. Other protocols and mechanisms can implement the general idea of using policy definitions for communicating the security metrics.

Specifically, to establish an optimal path through the network, the unified metric provisioned in PDP 605 would be communicated to all involved routers. Therefore, each Reservation Setup Agent 710 would make a choice of a route consistent with the calculation of a path that is optimal for a chosen metric.

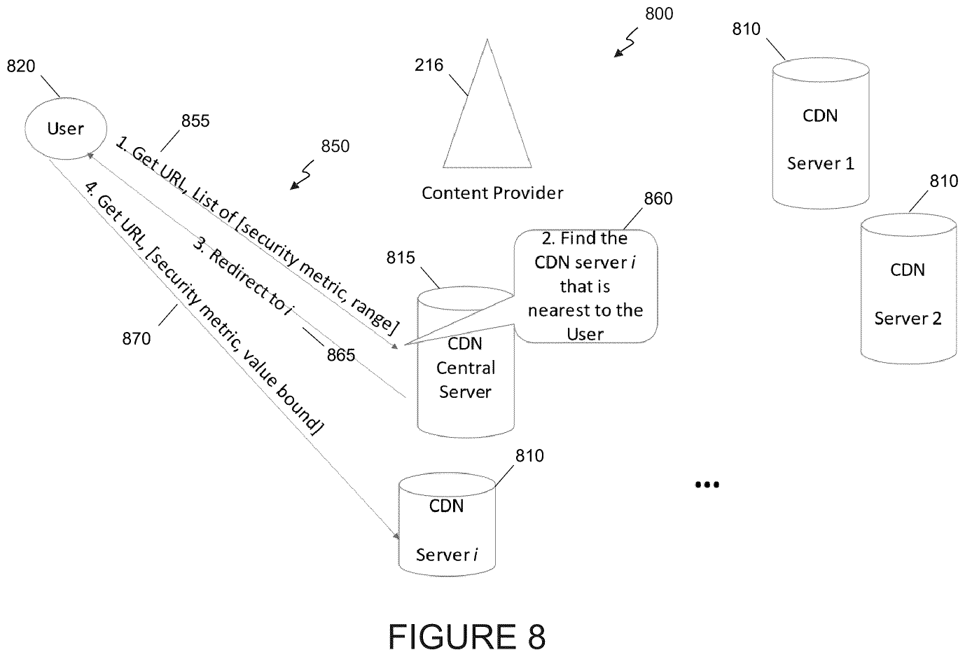

FIG. 8 illustrates a block diagram of a system 800 content delivery network (CDN) operation using the method described herein.

In system 800, the CDN provider 805 charges content providers for delivering their content efficiently. Then the CDN provider 805 pays the network providers to place the CDN servers 810 in specific locations.

Most of the original content stays on the provider's site, but the media universal resource locators are changed to point to a CDN's central server 815, whose job is to retrieve the media cached in its remote server. Once that CDN server 815 gets a request from a user 820, the CDN server 815 determines the user's location. Then the CDN server 815 finds the “nearest-to-the-user” (as determined by a multi-factor algorithm) the actual server 810 with the cached media. The CDN server 815 redirects the user 820 to the server 810 so found.

The factors used so far for determining the “distance” to the user 820 do not include any security-related parameters. However, a need for using security as a factor is becoming clearer in view of the growing sophistication of hackers. For example, a user 820 from a certain country may not trust a server 810 in the user's country (or some other specific country).

With the network analysis computer device 410 (shown in FIG. 4), the CDN provider 805 could exercise an ability to apply multiple security metrics to all its cashing servers and factor this metrics into determining the “shortest distance” to the user 820.

FIG. 8 also illustrates a process 850 of a possible implementation of a CDN operation in response to a user's request. The user 820, in the initial Hyper-Text Transmission Protocol (HTTP) GET request 855, may specify a list of desirable security metrics along with their acceptable value ranges. The CDN Central Server 815 factors 860 in these parameters into finding the “nearest” caching server i 810. The CDN Central Server 815 returns 865 the HTTP REDIRECT to the CDN caching server i 810. On receiving this, the user 820 issues 870 the GET request to i.

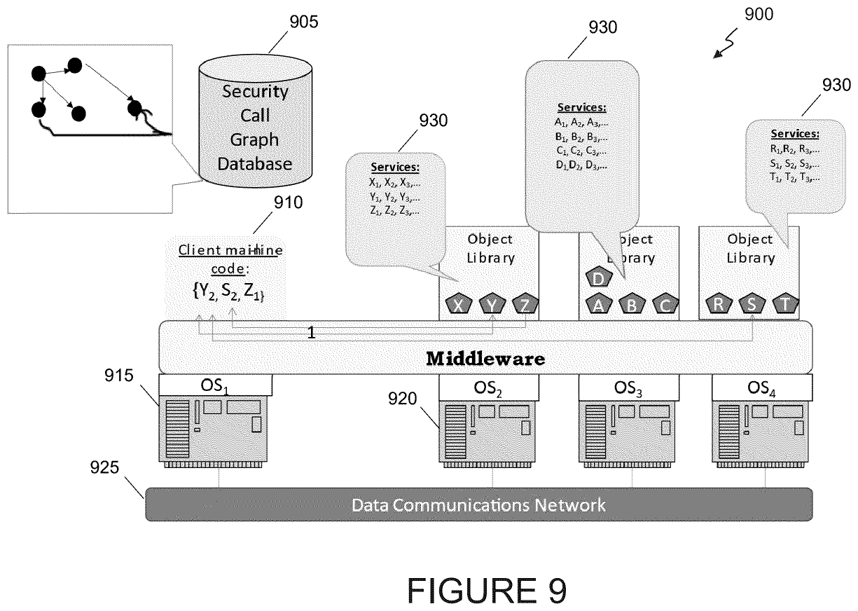

FIG. 9 illustrates an object oriented architecture 900 with a security call graph database (SCGD) 905. In this embodiment, the Network of software objects offer an implementation of advertised object-oriented interfaces. In this example, the network analysis computer device 410 (shown in FIG. 4) is applied the present art of distributed object-oriented computation.

As FIG. 9 demonstrates, the client 910 running on a machine 915 is capable (by means of Middleware such Common Object Request Broker Architecture (CORBA) or Service Oriented Architecture (SOA)) to access an object on another machine 920 across a data communications network 925. It is possible to provide multiple implementations of such objects by specifying an interface to which all such objects are then programmed. Thus, there is a multitude of choices as to which specific object to select to deliver a service 930. The security problem of making such choice is further complicated by the transitivity of the mechanism, since the invoked object may in turn invoke a method on another object and so forth.

To apply the network analysis computer device 410 to this environment, the data base containing a full graph of all advertised services and/or processes, which is called Security Call Graph Database (SCGD) 905, be created and maintained. In at least one embodiment, the SCGD 905 is maintained in the Broker. However, in other embodiments, other places may be used, including, but not limited to: compiler modifications to generate the code that queries and compiles the origins of all transitive objects into a SCGD 905 on the original host and a run-time environment protocol to establish the SCGD 905 on each host whenever a new implementation of an object or a method is advertised.

Depending on the choice of implementation, the “shortest security path” can be found by a client to affect an execution of a service. Other factors (i.e., performance or cost of execution) can be also included as described in previous embodiments

Another use of SCGD 905 described above is in an embodiment [claim] of workflow optimization. Workflows that specify the sequencing and inter-dependence of various tasks toward achieving a business objective have been in use for more than a century, and they have been naturally modelled as directed graphs. In the past two decades, as automation has progressed, workflows have been given extensive software support, with products developed by Microsoft and Amazon. In terms of software, workflow is described by a specification that defines and orders all the activities within a task. To automate a task involving a distributed system, its workflow must be defined in a way that it is executable in a distributed environment.

A workflow specification is a directed graph of activities, which is compiled to so that concurrent activities can run as separate processes, all of which maintain the state database. It is possible (with the existing compiler theory-based tools) to eliminate redundant activities and otherwise choose an optimal paths through a set of activities according to certain factors. This integration of applying the algorithm for metrics unification, enables the use of security metrics in determining the optimal path.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the network analysis computer device 410 (shown in FIG. 4) is configured to implement machine learning, such that the network analysis computer device 410 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, and/or other types of data (i.e., multi-modal type of data). ML outputs may include, but are not limited to identified objects, items classifications, textual product, and/or other data extracted from the images or textual data. In some embodiments, data inputs may include certain ML outputs (i.e., overall convergence optimization parameters or multiple localized convergence points that lack an optimal convergence point).

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of text with known characteristics or features. Such information may include, for example, information associated with different devices and their vulnerabilities and security features.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify devices in networks and determine the relative security of those devices. The processing element may also learn how to identify attributes of different devices and connections. This information may be used to determine which paths are the most secure between different devices.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), a reduced instruction set circuit (RISC), an application specific integrated circuit (ASIC), logic circuits, and any other circuit or processor capable of executing the functions described herein. The above examples are example only and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for network analysis, the system comprising:
a network analysis computer device in communication with a computer network, wherein the network analysis computer device comprises at least one processor in communication with at least one memory device, wherein the at least one processor is programmed to:
analyze a plurality of devices and a plurality of connections between the plurality of devices on the computer network;
determine values for each of the plurality of connections between the plurality of devices, wherein the plurality of values are determined based on a security posture of two devices of the plurality of devices on ends of the corresponding connection;
determine a plurality of paths between a first device of the plurality of devices and a second device of the plurality of devices;
calculate a security value for each of the plurality of paths; and
determine at least one secure path of the plurality of paths based on a comparison of the plurality of security values for the plurality of paths.

2. The system of claim 1, wherein the at least one processor is further programmed to determine the at least one secure path by comparing the plurality of security values to one or more thresholds.

3. The system of claim 1, wherein the at least one processor is further programmed to calculate the security value for each of the plurality of paths based on the corresponding plurality of values for the connections in the corresponding path.

4. The system of claim 1, wherein the plurality of values are weighted to so that a lower value is relatively more secure for use with one or more shortest path algorithms.

5. The system of claim 1, wherein the plurality of values are weighted so that a higher value is relatively more secure.

6. The system of claim 1, wherein the plurality of values are determined at least in part on one or more processes operating on the two devices on the ends of the corresponding connection.

7. The system of claim 1, wherein the plurality of values are determined at least in part on one or more software applications operating on the two devices on the ends of the corresponding connection.

8. The system of claim 1, wherein the plurality of values are determined at least in part on a network security and/or cryptographic controls of the two devices on the ends of the corresponding connection.

9. The system of claim 1, wherein the plurality of values are determined based on a quantum-safety of a connection, and wherein the at least one processor is further programmed to determine a shortest quantum-safe path.

10. The system of claim 1, wherein the at least one processor is further programmed to determine the at least one secure first path of the plurality of paths based on a comparison of the plurality of security values for the plurality of paths and one or more shortest path algorithms.

11. The system of claim 1, wherein the at least one processor is further programmed to determine one or more changes to a device of the plurality of devices to improve the values of one or more connections connected to that device.

12. The system of claim 1, wherein the at least one processor is further programmed to use graph theory to calculate one or more metrics associated with the plurality of values.

13. A method for network analysis of a computer network, the method implemented by a computer device comprising one or more processors in communication with one or more memory devices, the method comprising:
analyzing a plurality of devices and a plurality of connections between the plurality of devices on the computer network;
determining values for each of the plurality of connections between the plurality of devices, wherein the plurality of values are determined based on a security posture of two devices of the plurality of devices on ends of the corresponding connection;
determining a plurality of paths between a first device of the plurality of devices and a second device of the plurality of devices;
calculating a security value for each of the plurality of paths; and
determining at least one secure path of the plurality of paths based on a comparison of the plurality of security values for the plurality of paths.

14. The method of claim 13 further comprising determining the at least one secure path by comparing the plurality of security values to one or more thresholds.

15. The method of claim 13 further comprising calculating the security value for each of the plurality of paths based on the corresponding plurality of values for the connections in the corresponding path.

16. The method of claim 13, wherein the plurality of values are determined at least in part on one or more processes operating on the two devices on the ends of the corresponding connection and one or more software applications operating on the two devices on the ends of the corresponding connection.

17. The method of claim 13, wherein the plurality of values are determined at least in part on a cryptographic posture of the two devices on the ends of the corresponding connection.

18. The method of claim 13, wherein the plurality of values are determined based on a quantum-safety of a connection, and wherein the method further comprises determining a shortest quantum-safe path.

19. The method of claim 13 further comprising determining the at least one secure first path of the plurality of paths based on a comparison of the plurality of security values for the plurality of paths and one or more shortest path algorithms.

20. A computer device for network analysis of a computer network, the computer device comprising at least one processor in communication with at least one memory device, wherein the at least one processor is programmed to:
analyze a plurality of devices and a plurality of connections between the plurality of devices on the computer network;
determine values for each of the plurality of connections between the plurality of devices, wherein the plurality of values are determined based on a security posture of two devices of the plurality of devices on ends of the corresponding connection;
determine a plurality of paths between a first device of the plurality of devices and a second device of the plurality of devices;
calculate a security value for each of the plurality of paths; and
determine at least one secure path of the plurality of paths based on a comparison of the plurality of security values for the plurality of paths.
